(19) United States
(12) Patent Application Publication
(10) Pub. No.: US 2023/0146047 A1
(43) Pub. Date: May 11, 2023

(54) MAT ASSEMBLY

(71) Applicant: Cranetainer System US LLC, Mill Creek, WA (US)

(72) Inventor: Mark S. Mueller, SeaTac, WA (US)

(21) Appl. No.: 17/523,425

(22) Filed: Nov. 10, 2021

(51) Int. Cl. B32B 5/24; B32B 3/14; B32B 3/26; B32B 5/02; B32B 5/18; B32B 7/14; B32B 37/12; B32B 37/18; B32B 37/10

(52) U.S. Cl. CPC B32B 5/245; B32B 3/14; B32B 3/266; B32B 5/024; B32B 5/028; B32B 5/18; B32B 7/14; B32B 37/1292; B32B 37/182; B32B 37/10; B32B 2250/02; B32B 2255/02; B32B 2255/26; B32B 2262/0276; B32B 2266/08; B32B 2305/022; B32B 2305/188; B32B 2305/38; B32B 2367/00; B32B 2471/04; B25H 5/00

(57) ABSTRACT

Disclosed embodiments include mat assemblies and methods of fabricating a mat assembly. In an illustrative embodiment given by way of non-limiting example, a mat assembly includes a first mat defining first openings therein and a mesh member having a size and shape configured to underlie the first openings.

### TECHNICAL FIELD The present disclosure relates to mats for workspaces.

### BACKGROUND

Workers may perform work at height (that is, not standing on a floor of a structure) such as maintenance and construction work, like planned maintenance items, performing repairs, painting, cleaning, changing a vehicle's oil and/or oil filter, and the like. Such work at height may be performed while workers stand on various platforms, such as an expanded metal gangway, an expanded metal walkway, an expanded metal scaffold, a steel grating, or the like. Such work may also be performed while workers stand in a basket of an aerial work platform, such as a boom lift or the like. Regardless of specific type of platform, in general such platforms may include an expanded metal floor or other type of flat metal material with holes for expanded visibility.

Performing work while standing on hard surfaces, such as expanded metal surfaces or other type of flat metal material with holes for expanded visibility, may contribute to inducing fatigue in workers who perform work while standing on such hard surfaces for periods of time that may be lengthy.

In addition, small objects, such as without limitation tools, consumables and/or parts, such as for example and without limitation drill bits, screws, nails, bolts, nuts, washers, pencils, pens, and the like, may be dropped and may fall through interstitial spaces, openings, or holes in expanded metal surfaces or other type of flat metal material with holes for expanded visibility on which workers are working, thereby potentially presenting a safety hazard or a contamination hazard to personnel, equipment, products, or property located therebelow.

### SUMMARY

Disclosed embodiments include mat assemblies and methods of fabricating a mat assembly.

In an illustrative embodiment given by way of non-limiting example, a mat assembly includes a first mat defining first openings therein and a mesh member having a size and shape configured to underlie the first openings.

In another illustrative embodiment given by way of non-limiting example, a mat assembly includes a first mat subassembly including first mat sections, each first mat section defining first openings therein. A second mat subassembly includes second mat sections, each second mat section defining second openings therein that are alignable with the first openings. A mesh member is interposable between the first mat subassembly and the second mat subassembly and hays a size and shape configured to underlie the first openings.

In another illustrative embodiment given by way of non-limiting example, a non-limiting, illustrative method of fabricating a mat assembly includes: applying an adhesive onto first mat sections; disposing the first mat sections in a laterally spaced-apart manner; disposing a mesh member onto the first mat sections; and disposing second mat sections in a laterally spaced-apart manner onto the mesh member such that the second mat sections are aligned with the first mat sections.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the text (e.g., claims and/or detailed description) and/or drawings of the present disclosure.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1A is an exploded perspective view of an illustrative mat assembly.

FIG. 1B is a top plan view of the mat assembly of FIG. 1A.

FIG. 1C is a bottom plan view of the mat assembly of FIG. 1A.

FIG. 1D is a top plan view of a portion of the mat assembly of FIG. 1A.

FIG. 2 is an exploded perspective view of another illustrative mat assembly.

FIG. 3A is an exploded perspective view of another illustrative mat assembly.

FIG. 3B is a perspective view of another illustrative mat assembly disposed in a basket of an aerial work platform.

FIG. 3C is a top perspective view of the mat assembly of FIG. 3B.

FIG. 3D is a bottom perspective view of the mat assembly of FIG. 3B.

FIG. 3E is a perspective view of an illustrative mesh member of the mat assembly of FIG. 3B.

FIG. 3F is a perspective view of the mesh member of FIG. 3E disposed on mat sections of FIG. 3D.

FIG. 3G is a perspective view of the mat assembly of FIG. 3B disposed in a basket of an aerial work platform with mat sections folded.

FIG. 4A is a flow chart of an illustrative method of fabricating a mat assembly.

FIGS. 4B-4E are flow charts of illustrative details of the method of FIG. 4A.

The use of the same symbols in different drawings typically indicates similar or identical items unless context dictates otherwise.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

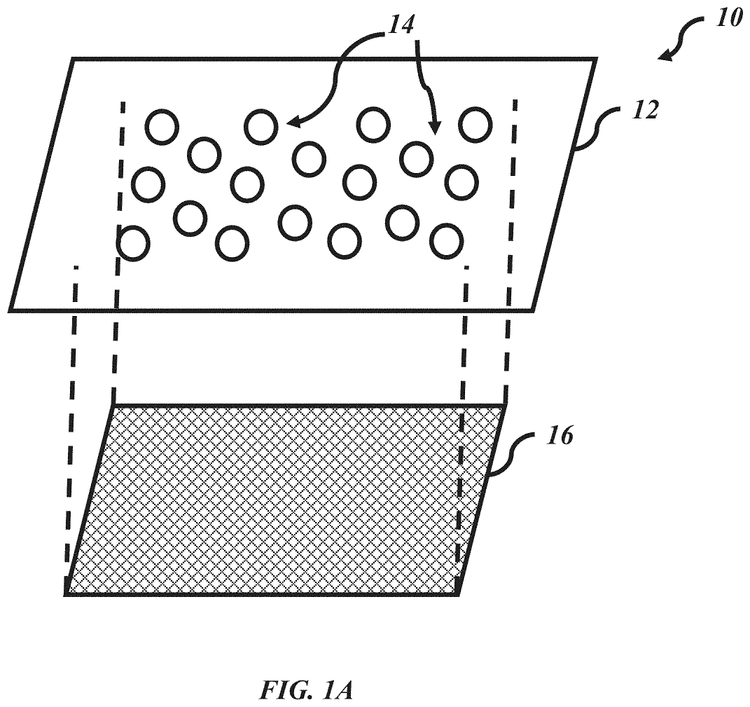

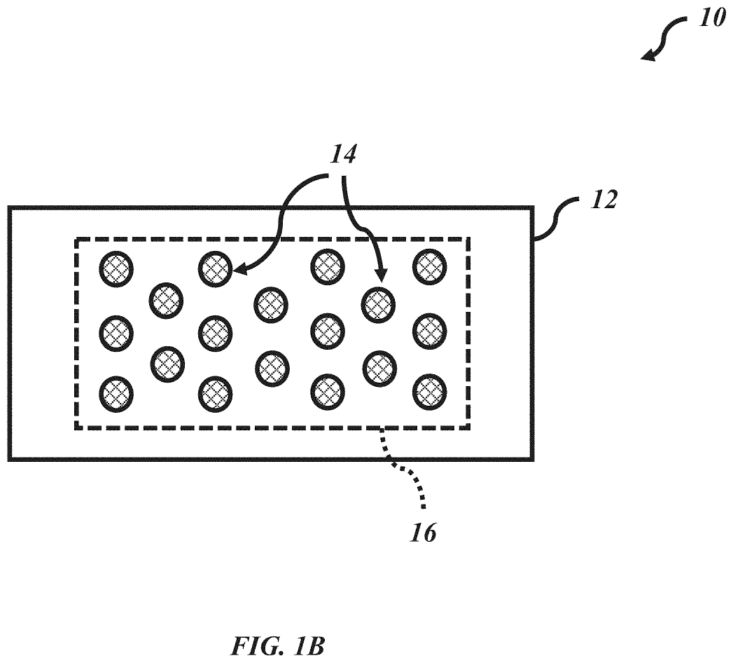

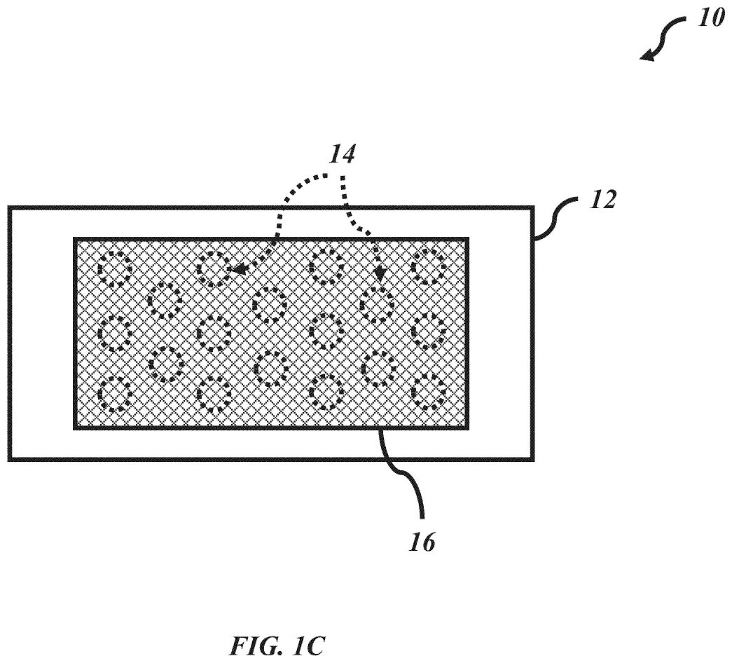

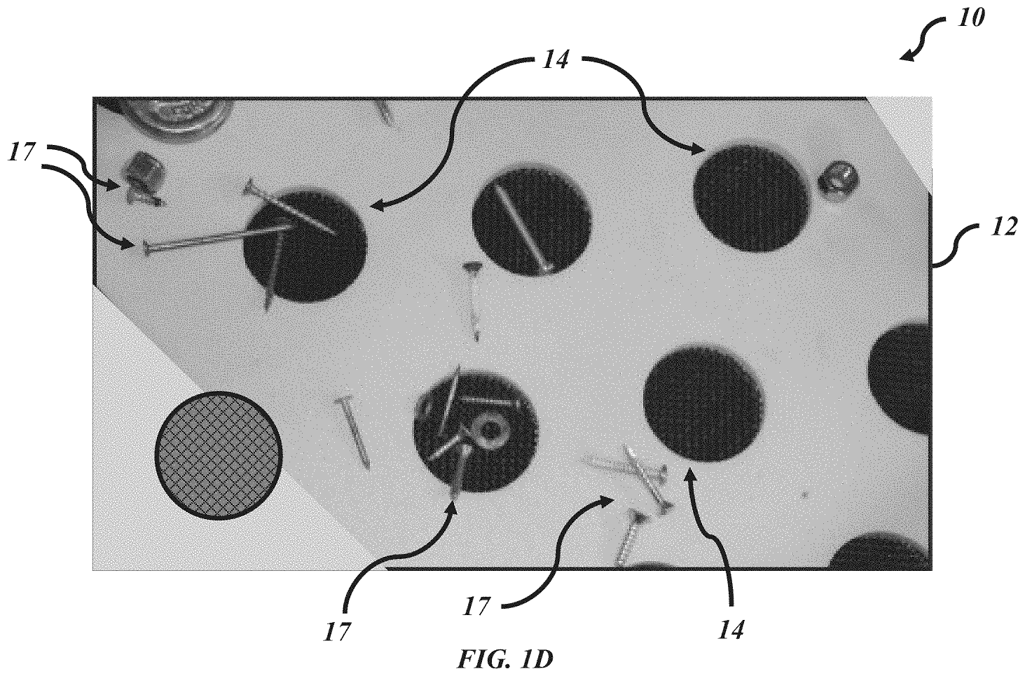

Given by way of non-limiting overview, various disclosed embodiments include mat assemblies and methods of fabricating a mat assembly. Still by way of overview and referring to FIGS. 1A-1D, in various embodiments an illustrative mat assembly 10 may be disposed on various platforms, such as an expanded metal gangway, an expanded metal walkway, an expanded metal scaffold, a steel grating, a basket of an aerial work platform, or the like. In various embodiments the mat assembly 10 includes a mat 12 that defines openings 14 therein and a mesh member 16 that has a size and shape configured to underlie the openings 14.

Now that a non-limiting overview has been given, details of various embodiments will be set forth by way of illustration only and not of limitation.

Still referring to FIGS. 1A-1D and as mentioned above, in various embodiments the mat assembly 10 includes the mat 12 and the mesh member 16.

In various embodiments the mat 12 may be made of a suitable closed cell foam. In various such embodiments, the closed cell foam may include a suitable plastic rubber material, such as without limitation ethylene-vinyl acetate copolymer (EVA) foam material, polyethylene foam, neoprene foam, polyvinyl chloride (PVC)/nitrile foam rubber, styrene-butadiene rubber (SBR) foam rubber, or the like, that is made up of internal pores or cells that sit closely together but are not connected.

In such embodiments, a closed cell foam construction of the mat 12 can help contribute to the mat assembly 10 withstanding many forces imparted by a worker or workers standing or stepping on objects 17 (FIG. 1D) caught by the mat assembly 10. In addition, in such embodiments a closed cell construction can help the mat 12 to help contribute to reducing worker fatigue compared to fatigue experienced by workers performing the same work while standing or kneeling on expanded metal surfaces or other types of flat metal material. Further, in such embodiments a closed cell construction can help the mat 12 to help contribute to providing increased traction to workers compared to traction available to workers performing the same work on expanded metal surfaces or other types of flat metal material.

In various embodiments and as shown in FIG. 1C, the mesh member 16 has a size and shape configured to underlie the openings 14. Moreover, in various embodiments the mesh member 16 may define an interlaced weave that has openings smaller than the openings 14 that are defined in the mat 12. Accordingly, small objects 17, such as without limitation tools, consumables and/or parts, such as for example and without limitation drill bits, screws, nails, bolts, nuts, washers, pencils, pens, and the like, that may be dropped do not fall through the mesh member 16. Thus, such items that may be dropped but do not fall through the openings in the mesh member 16 are prevented from falling through interstitial spaces, openings, or holes in expanded metal surfaces or other type of flat metal material with holes for expanded visibility on which workers are working.

It will be appreciated that any number of the openings 14 may be defined in the mat 12 as desired for a particular application. In addition, the openings 14 may have any size or shape as desired and may be arranged in any pattern (or arranged randomly) as desired.

In addition, in various embodiments a worker or workers can see through the openings 14 defined in the mat 12 and the openings in the interlaced weave of the mesh member 16. An ability to see through the openings 14 defined in the mat 12 and the openings in the interlaced weave of the mesh member 16 can help provide a worker or workers with an increased situational awareness and/or, if applicable, can help contribute to helping raise or lower an aerial work platform more safely.

In various embodiments the mesh member 16 may include a high-strength mesh such as, without limitation, a vinyl-coated polyester mesh. In such embodiments, a vinyl-coated polyester construction of the mesh member 16 can help contribute to the mat assembly 10 withstanding many forces imparted by a worker or workers standing or stepping on objects 17 caught by the mat assembly 10.

In various embodiments, if desired the mesh member 16 may be attachable to the mat 12. In some such embodiments, the mesh member 16 may be sewn to the mat 12. However, in some other embodiments the mat 12 and the mesh member 16 may be separate pieces that are not attached to each other. In such embodiments, the mesh member 16 may be disposed, such as by placing, rolling, unfolding, or the like, on a platform, such as an expanded metal gangway, an expanded metal walkway, an expanded metal scaffold, a steel grating, a basket of an aerial work platform, or the like. In such embodiments the mat 12 may be placed on top of the mesh member 16 such that the mesh member 16 underlies the openings 14 in the mat 12.

As shown in FIGS. 1A-1C, in some embodiments the mat assembly 10 includes only the mat 12 that is disposable on top of the mesh member 16. For example, such embodiments may find applicability in work evolutions that entail shorter durations that may impart lower levels of fatigue to workers as a result of shorter durations.

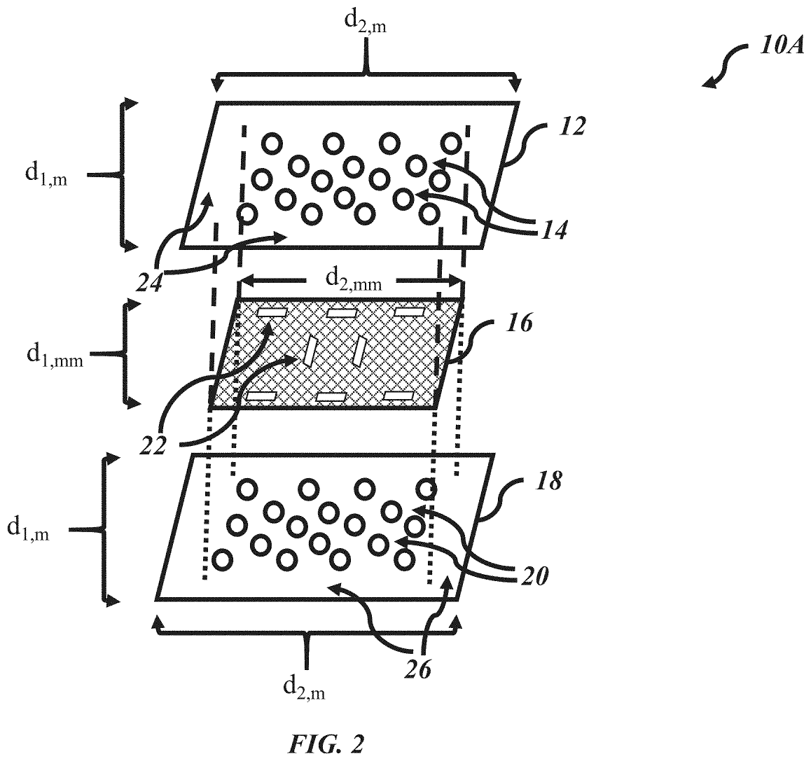

However, in some other situations it may be desirable, for example, to provide more cushioning in addition to that provided by just the mat 12. To that end and referring additionally to FIG. 2, in some other embodiments a mat assembly 10A may include the mat 12 and the mesh member 16 and may also include a mat 18 that defines openings 20 therein that are alignable with the openings 14. In such embodiments the mat 18 may be configured to underlie the mesh member 16.

It will be appreciated that in such embodiments (in which the mat 18 may be configured to underlie the mesh member 16) a user can see through the openings 20 in the mat 18 and the mesh member 16 because the openings 20 in the mat 18 align with the openings 14 in the mat 12. It will be appreciated that, in such embodiments, a worker or workers can see through the openings 14 defined in the mat 12 and the openings in the interlaced weave of the mesh member 16. An ability to see through the openings 14 defined in the mat 12 and the openings in the interlaced weave of the mesh member 16 can help provide a worker or workers with an increased situational awareness and/or, if applicable, can help contribute to helping raise or lower an aerial work platform more safely.

In some such embodiments, both of the mats 12 and 18 may be made of a closed cell foam such as, without limitation, a suitable plastic rubber material like ethylene-vinyl acetate copolymer (EVA) foam material, polyethylene foam, neoprene foam, polyvinyl chloride (PVC)/nitrile foam rubber, styrene-butadiene rubber (SBR) foam rubber, or the like. As mentioned above, in some embodiments the mat 12 may be made of a closed cell foam. In some embodiments, the mat 18 also may be made of a closed cell foam. It will be appreciated that, in such embodiments, making both of the mats 12 and 18 of a closed cell foam can help contribute to withstanding greater forces imparted by a worker or workers standing or stepping on objects 17 caught by the mat assembly 10 than in embodiments in which only the mat 12 is provided (and made of a closed cell foam) because an additional layer of closed cell foam is disposed between the mat 10 and the metal floor or surface on which the mat assembly 10 is disposed. It will also be appreciated that, in such embodiments, making both of the mats 12 and 18 of a closed cell foam provides an additional, closed cell foam cushioning layer over embodiments in which only the mat 12 is provided (and made of a closed cell foam). It will be appreciated that such an additional closed cell foam cushioning layer can help contribute to reducing worker fatigue even more than embodiments in which only the mat 12 is provided (and made of a closed cell foam).

In various embodiments the mat 12 and the mat 18 are attachable to each other. Given by way of non-limiting example, the mats 12 and 18 may be attached to each other with an adhesive, such as without limitation a suitable high-strength, all-purpose glue.

In such embodiments, the mesh member 16 is configured to permit the mats 12 and 18 to be attached to each other with an adhesive. For example, in some such embodiments the mesh member 16 defines therein openings 22 that are laterally spaced apart from the openings 14 and the openings 20. The openings 22 permit the adhesive to be disposed therethrough, thereby permitting the adhesive to contact the mats 12 and 18. It will be appreciated that any number of the openings 22 may be defined in the mesh member 16 as desired for a particular application. In addition, the openings 22 may have any size or shape as desired and may be arranged in any pattern (or arranged randomly) as desired, so long as the openings 22 are laterally spaced apart from the openings 14 and the openings 20.

As another example, in some such embodiments the mesh member 16 is sized and shaped to permit the mats 12 and 18 to be attached to each other with an adhesive. For example, in some such embodiments the mesh member 16 may have dimensions d_{1,mm} and d_{2,mm} that are shorter than respective dimensions d_{1,m} and d_{2,m} of the mats 12 and 18. Peripheries 24 and 26 of the mats 12 and 18, respectively, extend past edges of the mesh member 16. In such embodiments, adhesive may be applied to the peripheries 24 and 26 of the mats 12 and 18, respectively, thereby contacting the mats 12 and 18.

In various embodiments, the mesh member 16 may include a high-strength mesh such as, without limitation, a vinyl-coated polyester mesh.

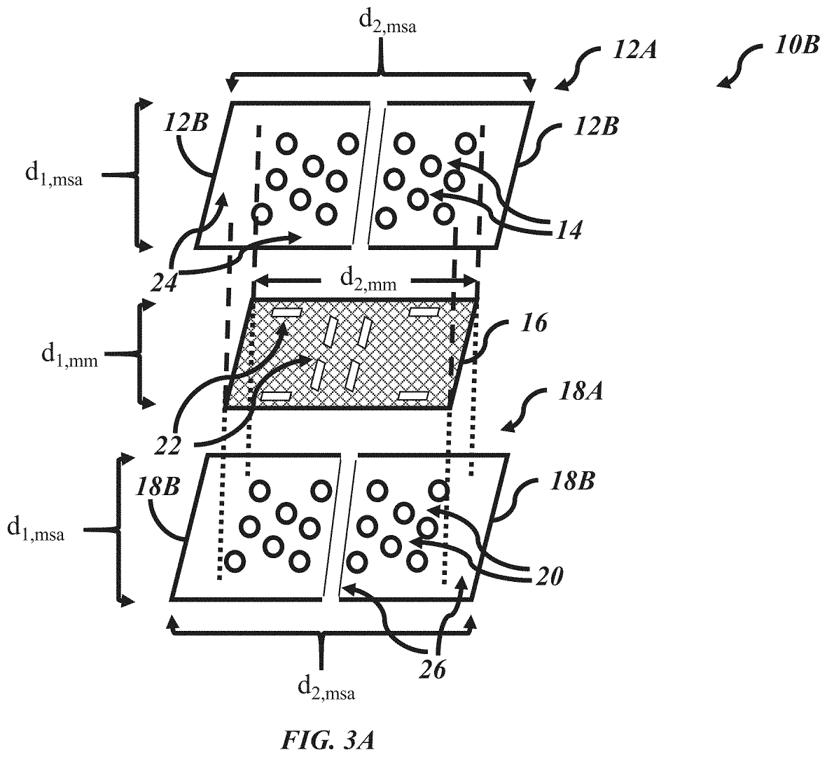

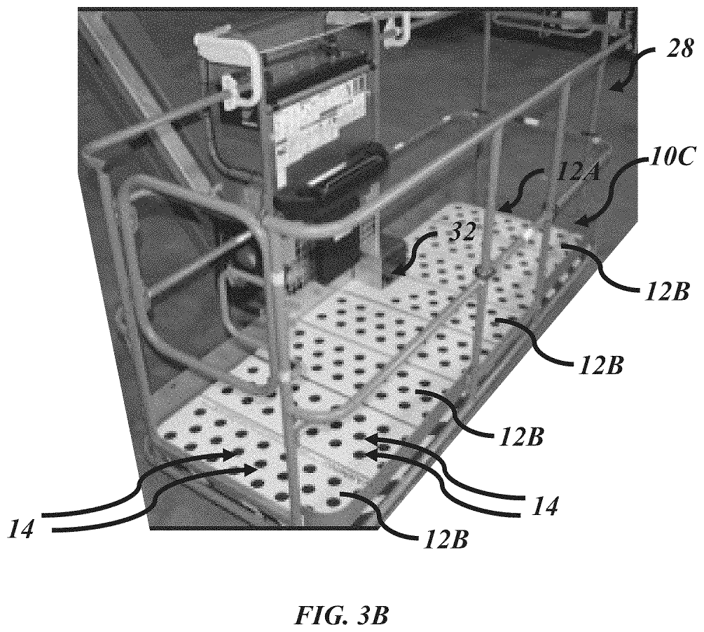

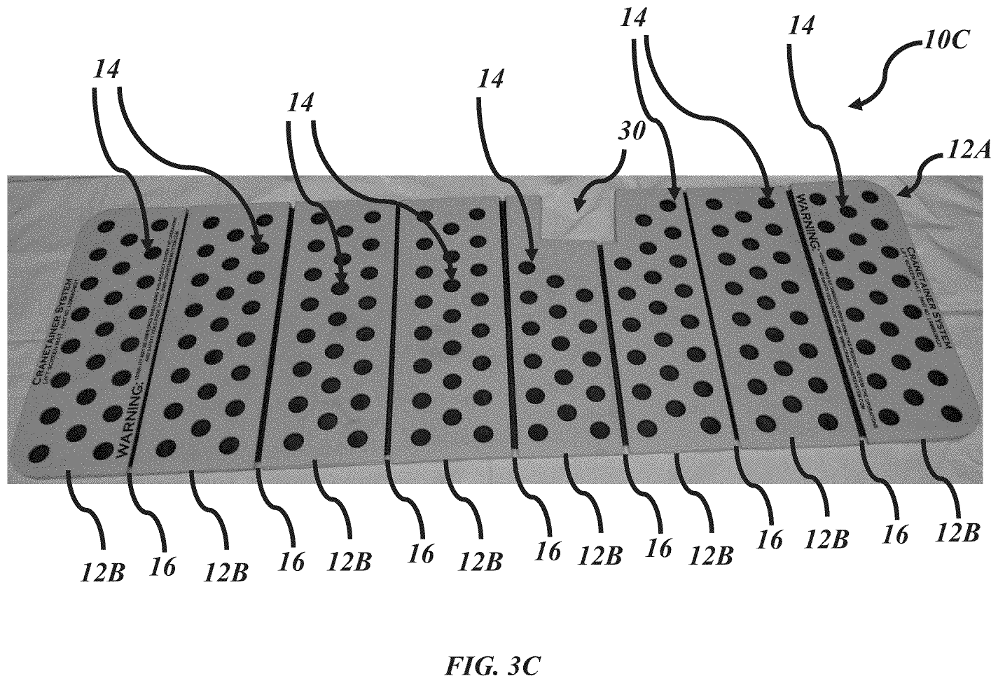

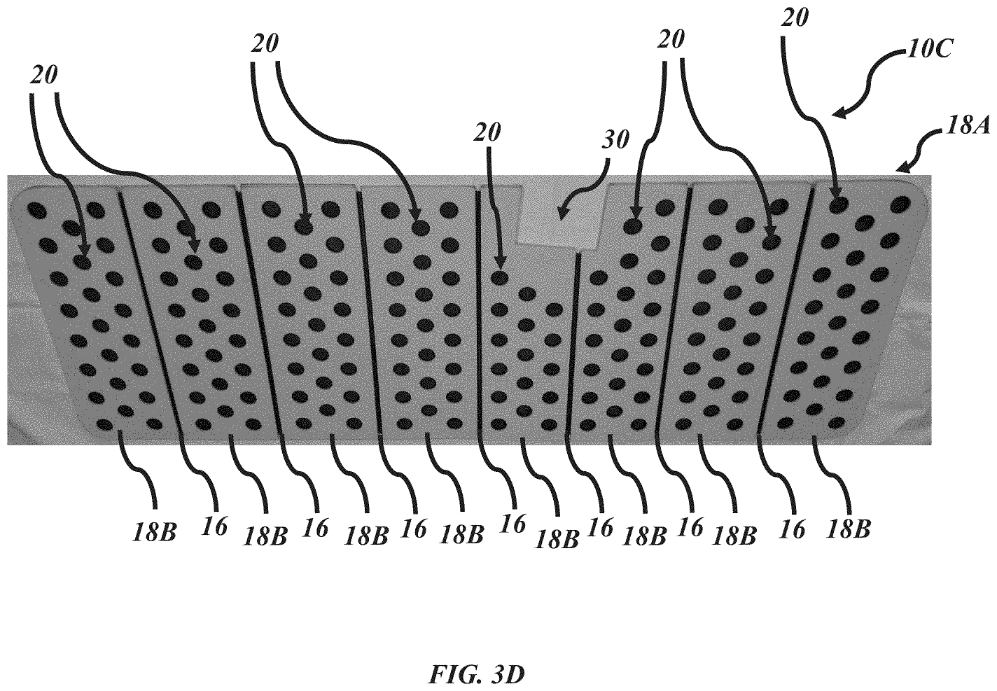

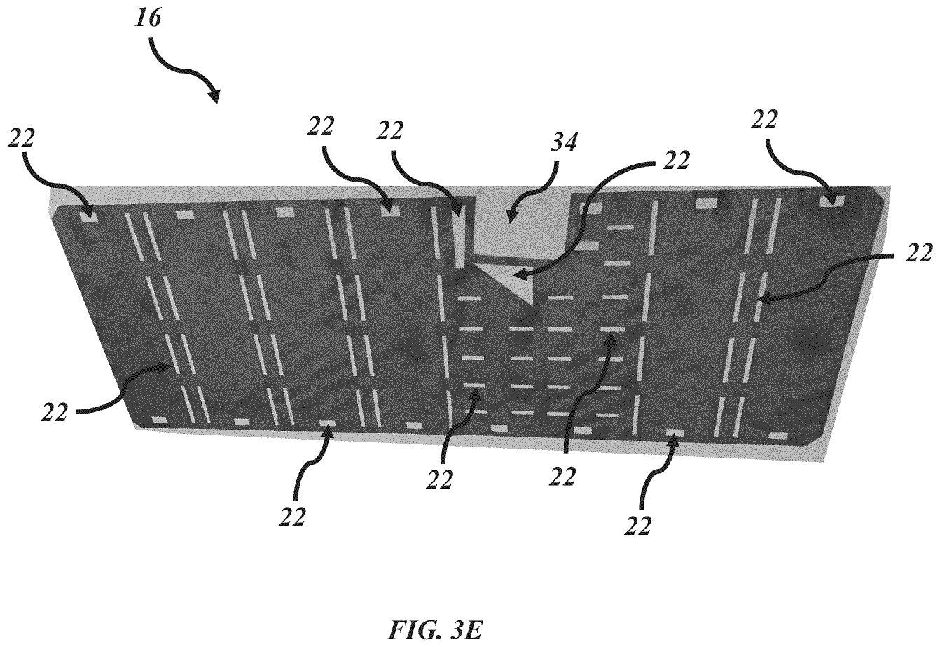

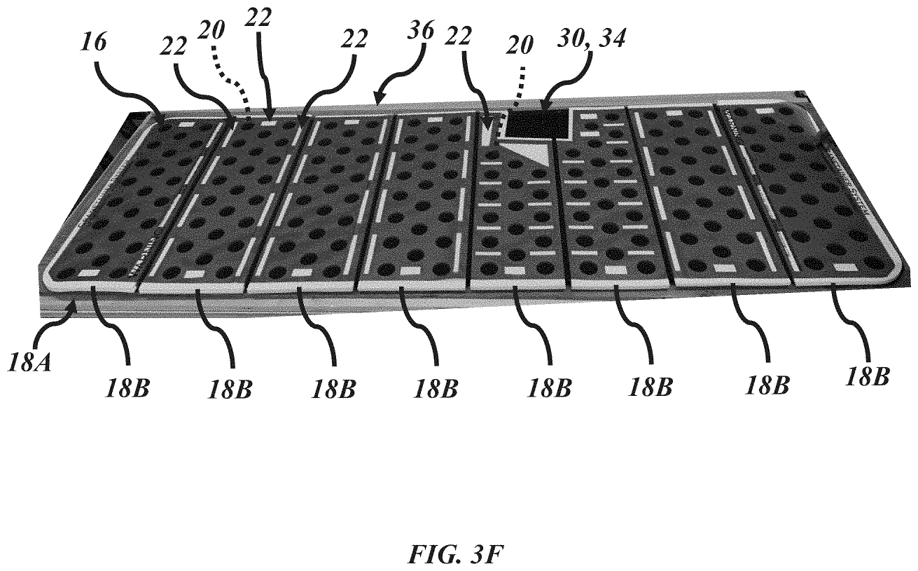

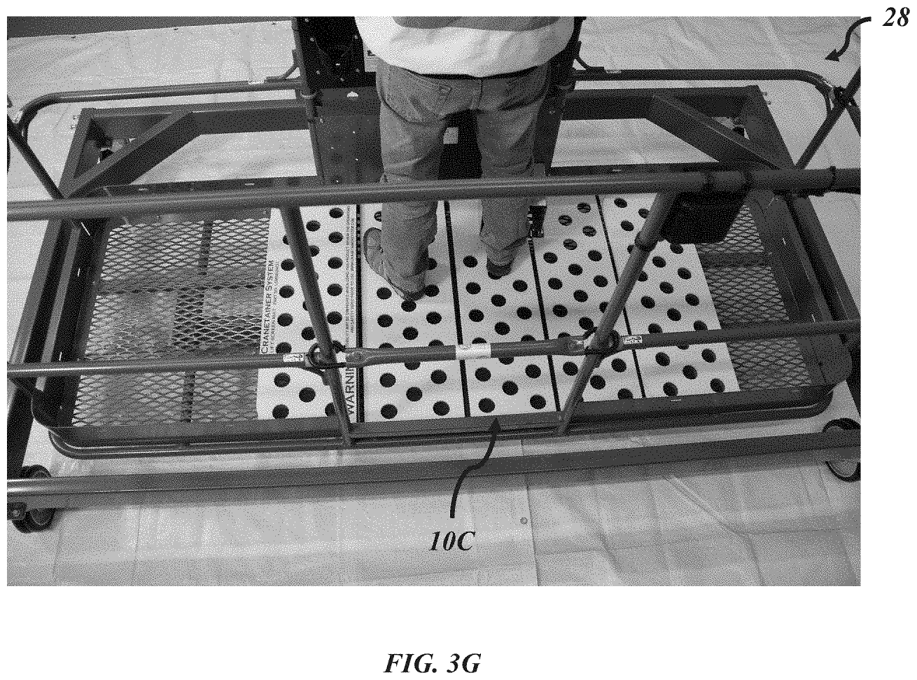

Referring additionally to FIG. 3A, in various embodiments a mat assembly 10B may include multiple mat subassemblies as opposed to only including one mat 12 (FIGS. 1A-1C) or one mat 12 and one mat 18 (FIG. 2). It will be appreciated that including multiple mat subassemblies may help contribute to providing the mat assembly 10B with additional functionality as discussed below. In the following description, similar or the same reference numbers denote similar or the same items discussed previously.

As shown in FIG. 3A, in various embodiments a mat assembly 10B includes a mat subassembly 12A that includes mat sections 12B and 18B. Each mat section 12B defines openings 14 therein and each mat section 18B defines openings 20 therein that are alignable with the openings 14. A mesh member 16 is interposable between the mat subassembly 12A and the mat subassembly 18A. The mesh member 16 has a size and shape configured to underlie the openings 14. Thus, it will be appreciated that, in various embodiments, one mesh member 16 is interposed between all of the mat subassemblies 12A and 18A.

It will be appreciated that the mat assembly 10B may include any number of the mat sections 12B and 18B as desired for a particular application. While only two mat sections 12B and 18B are shown in FIG. 3A for purposes of clarity, it will be appreciated that no such limitation is intended and is not to be inferred. As such, it is emphasized that the mat assembly 10B may include any number of the mat sections 12B and 18B as desired for a particular application.

As mentioned above, similar or the same reference numbers denote similar or the same items discussed previously. As an example, in various embodiments the mat sections 12B and 18B are similar to the mats 12 and 18, respectively (FIG. 2). For example, in various embodiments the mat sections 12B and the mat sections 18B are made of a closed cell foam such as, without limitation, a suitable plastic rubber material like ethylene-vinyl acetate copolymer (EVA) foam material, polyethylene foam, neoprene foam, polyvinyl chloride (PVC)/nitrile foam rubber, styrene-butadiene rubber (SBR) foam rubber, or the like. As another example, any number of the openings 14 and 20 may be defined in the mat sections 12B and 18B, respectively, as desired for a particular application. As another example, the openings 14 and 18 may have any size or shape as desired and may be arranged in any pattern (or arranged randomly) as desired—so long as the openings 14 and 18 are alignable with each other (thus permitting a user to see through the openings 20 in the mat sections 18B, the mesh member 16, and the openings 14 in the mat sections 12B because the openings 20 in the mat sections 18B align with the openings 14 in the mat sections 12B).

As another example, in various embodiments the mesh member 16 defines an interlaced weave having openings smaller than the openings 14 in the mat sections 12B and the openings 20 in the mat sections 18B. As another example, in various embodiments the mesh member 16 includes a vinyl-coated polyester mesh.

In various embodiments associated ones of the mat sections 12B and ones of the mat sections 18B—that is, mat sections 12B and 18B that are vertically aligned with each other—are attachable to each other. Given by way of non-limiting example, the mat sections 12B and 18B may be attached to each other with an adhesive, such as without limitation a suitable high-strength, all-purpose glue.

In such embodiments, the mesh member 16 is configured to permit the associated mat sections 12B and 18B to be attached to each other with an adhesive (discussed above). For example, in various embodiments the mesh member 16 defines therein openings 22 that are laterally spaced apart from the openings 14 and the openings 20. The openings 22 permit the adhesive to be disposed therethrough, thereby permitting the adhesive to contact the mat sections 12B and 18B. It will be appreciated that any number of the openings 22 may be defined in the mesh member 16 as desired for a particular application. In addition, the openings 22 may have any size or shape as desired and may be arranged in any pattern (or arranged randomly) as desired, so long as the openings 22 are laterally spaced apart from the openings 14 and the openings 20.

As another example, in some such embodiments the mesh member 16 is sized and shaped to permit the associated mat sections 12B and 18B to be attached to each other with an adhesive. For example, in some such embodiments the mesh member 16 may have dimensions d_{1,mm} and d_{2,mm} that are shorter than respective dimensions d_{1,msa} and d_{2,msa} of the mat subassemblies 12A and 18A. Peripheries 24 and 26 of the mat sections 12B and 18B, respectively, extend past edges of the mesh member 16. In such embodiments, adhesive may be applied to the peripheries 24 and 26 of the mat sections 12B and 18B, respectively, thereby contacting the mat sections 12B and 18B.

In various embodiments, the mesh member 16 may include a high-strength mesh such as, without limitation, a vinyl-coated polyester mesh.

In various embodiments, ones of the mat sections 12B and ones of the mat sections 18B are laterally spaced apart from adjacent ones of the mat sections 12B and ones of the mat sections 18B, respectively, such that associated mat sections 12B and 18B are foldable onto adjacent associated mat sections 12B and 18B. As will be discussed further below, such embodiments can help permit increased visibility as desired.

Referring additionally to FIGS. 3B-3G, various embodiments may be provided for use in various applications as desired. Given by way of non-limiting example and as shown in FIG. 3B, in various embodiments a mat assembly 10C may be disposed in a basket 28 of an aerial work platform (not shown). However, as discussed above, it will be appreciated that various disclosed mat assemblies may be provided for use in any suitable application as desired, such as without limitation work settings on a platform, such as an expanded metal gangway, an expanded metal walkway, an expanded metal scaffold, a steel grating, a basket of an aerial work platform, or the like.

For example and as shown in FIGS. 3B, 3C, and 3D, in various embodiments a mat assembly 10C includes multiple mat sections 12B (FIGS. 3B and 3C) and 18B (FIG. 3D). Each mat section 12B defines openings 14 therein and each mat section 18B defines openings 20 therein that are alignable with the openings 14. A mesh member 16 is interposable between the mat subassembly 12A and the mat subassembly 18A. The mesh member 16 has a size and shape configured to underlie the openings 14. Thus, similar to the mat assembly 10B (FIG. 3A), one mesh member 16 is interposed between all of the mat subassemblies 12A and 18A.

It will be appreciated that the mat assembly 10C may include any number of the mat sections 12B and 18B as desired for a particular application. It will also be appreciated that the mat sections 12B and 18B may be sized and shaped as desired for a particular application. For example, in some embodiments the mat assembly 10C may include a number of mat sections 12B and 18B that are sized and shaped for use in any suitable setting, such as without limitation the aerial basket 28. For example, in various embodiments a cutout 30 may be defined in one of the mat assemblies 12B (FIGS. 3B and 3C) and an associated one of the mat assemblies 18B (FIG. 3D) to permit the mat assembly 10C to be fitted about a “dead man's” switch 32 (FIG. 3B) disposed in the basket 28. However, it is again emphasized that the mat assembly 10C may be used in any other suitable application as desired, such as without limitation work settings on an expanded metal gangway, an expanded metal walkway, an expanded metal scaffold, a steel grating, or the like.

In various embodiments the mat sections 12B and 18B are made of a closed cell foam such as, without limitation, a suitable plastic rubber material like ethylene-vinyl acetate copolymer (EVA) foam material, polyethylene foam, neoprene foam, polyvinyl chloride (PVC)/nitrile foam rubber, styrene-butadiene rubber (SBR) foam rubber, or the like. As another example, any number of the openings 14 and 20 may be defined in the mat sections 12B and 18B, respectively, as desired for a particular application. As another example, the openings 14 and 18 may have any size or shape as desired and may be arranged in any pattern (or arranged randomly) as desired—so long as the openings 14 and 18 are alignable with each other (thus permitting a user to see through the openings 20 in the mat sections 18B, the mesh member 16, and the openings 14 in the mat sections 12B because the openings 20 in the mat sections 18B align with the openings 14 in the mat sections 12B).

As another example, in various embodiments the mesh member 16 defines an interlaced weave having openings smaller than the openings 14 in the mat sections 12B and the openings 20 in the mat sections 18B. As another example, in various embodiments the mesh member 16 includes a vinyl-coated polyester mesh.

In various embodiments associated ones of the mat sections 12B and ones of the mat sections 18B—that is, mat sections 12B and 18B that are vertically aligned with each other—are attachable to each other. Given by way of non-limiting example, the mat sections 12B and 18B may be attached to each other with an adhesive, such as without limitation a suitable high-strength, all-purpose glue.

Referring additionally to FIGS. 3E and 3F, in various embodiments the mesh member 16 is configured to permit the associated mat sections 12B and 18B to be attached to each other with an adhesive (discussed above). For example, in various embodiments the mesh member 16 defines therein openings 22 that are laterally spaced apart from the openings 14 and the openings 20. The openings 22 permit the adhesive to be disposed therethrough, thereby permitting the adhesive to contact the mat sections 12B and 18B. It will be appreciated that any number of the openings 22 may be defined in the mesh member 16 as desired for a particular application. In addition, the openings 22 may have any size or shape as desired and may be arranged in any pattern (or arranged randomly) as desired, so long as the openings 22 are laterally spaced apart from the openings 14 and the openings 20. As shown in FIGS. 3E and 3F, the mesh member 16 may define a cutout 34 to permit the mat assembly 10C to be fitted about the “dead man's” switch 32 (FIG. 3B) disposed in the basket 28 (FIG. 3B). As shown in FIG. 3F, the mesh member 16 has been disposed on the mat sections 18B (either the mat sections 12B or the mat sections 18B) that have been placed on tooling 36 (such as a jig or the like) as part of the process of fabricating the mat assembly 10C. However, it will be appreciated that the mesh member 16 may be disposed on either the mat sections 12B or the mat sections 18B as part of the process of fabricating the mat assembly 10C.

In various embodiments and as shown in FIG. 3G, sections of the mat assembly 10C may be folded as desired, thereby helping to increase visibility. In some such embodiments and as shown in FIGS. 3C and 3D, ones of the mat sections 12B and ones of the mat sections 18B are laterally spaced apart from adjacent ones of the mat sections 12B and adjacent ones of the mat sections 12B, respectively, such that associated mat sections 12B and 18B are foldable onto adjacent associated mat sections 12B and 18B. As shown in FIG. 3G, in some such embodiments associated mat sections 12B and 18B may be folded onto adjacent mat sections 12B and 18B — working inwardly from mat sections 12B and 18B at ends of the mat assembly 10C that cover areas of a workspace where coverage by the mat assembly 10C is not necessary for a particular evolution. The folded mat sections 12B and 18B are stacked vertically on adjacent mat sections 12B and 18B. Areas of the floor of the basket 28 that were covered with the mat sections 12B and 18B that have been folded onto adjacent mat sections 12B and 18B are no longer covered by the mat assembly 10C, thereby permitting a worker to have increased visibility through the floor of the basket 28 in such uncovered areas.

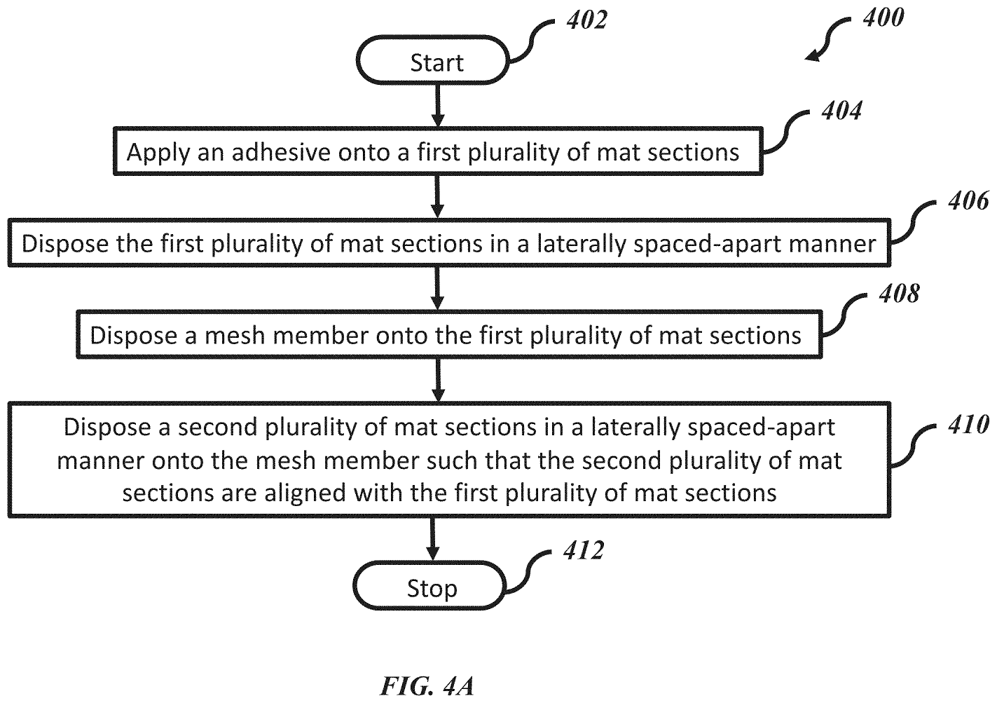

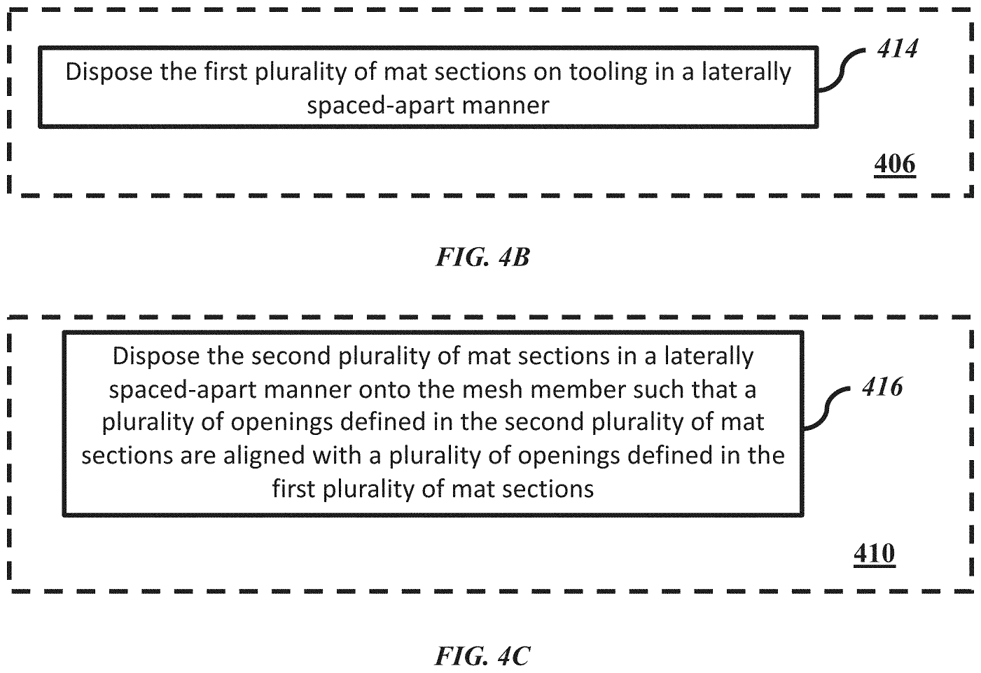

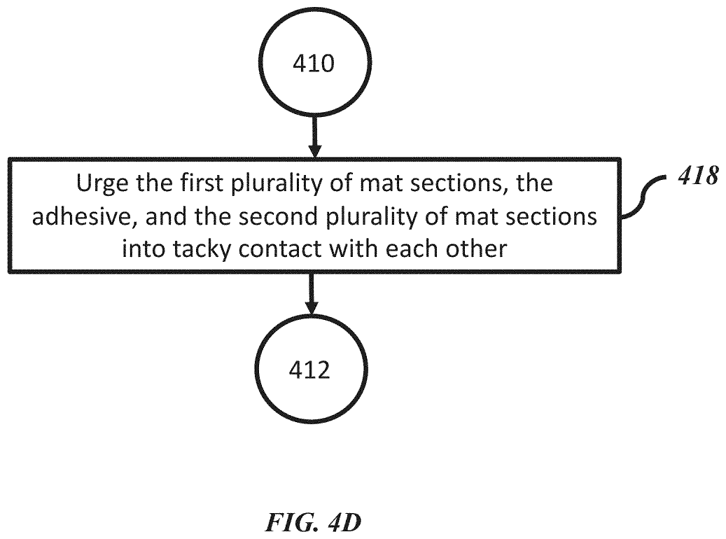

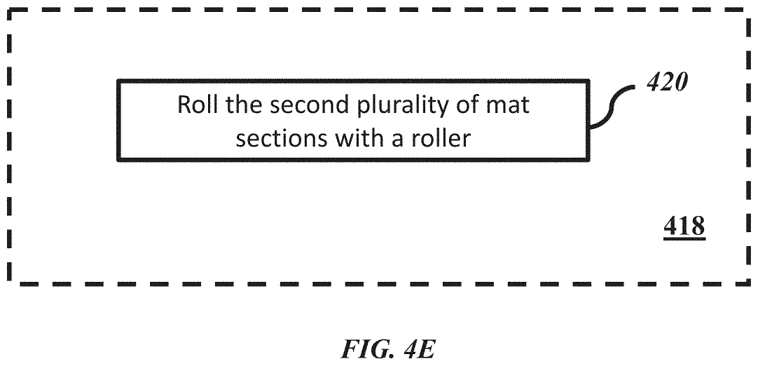

Referring additionally to FIGS. 4A-4E, an illustrative method 400 is provided for fabricating a mat assembly.

As shown in FIG. 4A, the method 400 starts at a block 402. At a block 404 an adhesive is applied onto a first plurality of mat sections. For example, in some embodiments a glue, such as a high-strength, all-purpose glue, may be sprayed, brushed, poured, or otherwise applied onto the first plurality of mat sections in any suitable manner as desired.

At a block 406 the first plurality of mat sections is disposed in a laterally spaced-apart manner It will be appreciated that no order of operations is intended regarding operations at the blocks 404 and 406. That is, in some embodiments the adhesive may be applied onto the first plurality of mat sections at the block 404 before the first plurality of mat sections is disposed in a laterally spaced-apart manner at the block 406. In some other embodiments the first plurality of mat sections may be disposed in a laterally spaced-apart manner at the block 406 before the adhesive is applied onto the first plurality of mat sections at the block 404.

At a block 408 a mesh member is disposed onto the first plurality of mat sections. At a block 410 a second plurality of mat sections is disposed in a laterally spaced-apart manner onto the mesh member such that the second plurality of mat sections are aligned with the first plurality of mat sections. The method 400 stops at a block 412.

It will be appreciated that use of the terms “first” and “second” in relation to “plurality of mat sections” is used only to distinguish that the first plurality of mat sections is different from the second plurality of mat sections and that no particular set of mat sections are intended to be included in either the first plurality of mat sections or the second plurality of mat sections.

In various embodiments and as shown in FIG. 4B, disposing the first plurality of mat sections in a laterally spaced-apart manner at the block 406 may include disposing the first plurality of mat sections on tooling in a laterally spaced-apart manner at a block 414. For example, the first plurality of mat sections may be placed or otherwise disposed on or in tooling, such as without limitation a jig or the like, such that the plurality of first mat sections are laterally spaced apart from each other.

In various embodiments and as shown in FIG. 4C, disposing the second plurality of mat sections in a laterally spaced-apart manner onto the mesh member such that the second plurality of mat sections are aligned with the first plurality of mat sections at the block 410 may include disposing the second plurality of mat sections in a laterally spaced-apart manner onto the mesh member such that a plurality of openings defined in the second plurality of mat sections are aligned with a plurality of openings defined in the first plurality of mat sections at a block 416.

In various embodiments and as shown in FIG. 4D, at a block 418 the first plurality of mat sections, the adhesive, and the second plurality of mat sections may be urged into tacky contact with each other. In some embodiments and as shown in FIG. 4E, urging the first plurality of mat sections, the adhesive, and the second plurality of mat sections into tacky contact with each other at the block 418 may include rolling the second plurality of mat sections with a roller at a block 420.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It will also be appreciated that, in the claims, use of the terms “first” and “second” in relation to “mat,” “mat subassembly,” and “plurality of mat sections” is used only to distinguish that the first mat, mat subassembly, or plurality of mat sections is different from the second mat, mat subassembly, or plurality of mat sections and that no particular mat, mat subassembly, or plurality of mat sections are intended to be included in either the first mat, mat subassembly, or plurality of mat sections or the second mat, mat subassembly, or plurality of mat sections.

While a number of illustrative embodiments and aspects have been illustrated and discussed above, those of skill in the art will recognize certain modifications, permutations, additions, and sub-combinations thereof It is therefore intended that the following appended claims and claims hereafter introduced are interpreted to include all such modifications, permutations, additions, and sub-combinations as are within their true spirit and scope.

What is claimed is:

1. A mat assembly comprising:
a first mat defining a first plurality of openings therein; and
a mesh member having a size and shape configured to underlie the first plurality of openings.

2. The mat assembly of claim 1, wherein the first mat is made of a closed cell foam.

3. The mat assembly of claim 1, wherein the mesh member defines an interlaced weave having openings smaller than the first plurality of openings defined in the first mat.

4. The mat assembly of claim 1, wherein the mesh member includes a vinyl-coated polyester mesh.

5. The mat assembly of claim 1, wherein the mesh member is attachable to the first mat.

6. The mat assembly of claim 1, further comprising a second mat defining a second plurality of openings therein that are alignable with the first plurality of openings, the second mat being configured to underlie the mesh member.

7. The mat assembly of claim 6, wherein the first mat and the second mat are made of a closed cell foam.

8. The mat assembly of claim 6, wherein the first mat and the second mat are attachable to each other.

9. A mat assembly comprising:
a first mat subassembly including a plurality of first mat sections, each first mat section defining a first plurality of openings therein;
a second mat subassembly including a plurality of second mat sections, each second mat section defining a second plurality of openings therein that are alignable with the first plurality of openings; and
a mesh member interposable between the first mat subassembly and the second mat subassembly having a size and shape configured to underlie the first plurality of openings.

10. The mat assembly of claim 9, wherein the plurality of first mat sections and the plurality of second mat sections are made of a closed cell foam.

11. The mat assembly of claim 9, wherein the mesh member defines an interlaced weave having openings smaller than the first and second pluralities of openings.

12. The mat assembly of claim 9, wherein the mesh member includes a vinyl-coated polyester mesh.

13. The mat assembly of claim 9, wherein associated ones of the plurality of first mat sections and ones of the plurality of second mat sections are attachable to each other.

14. The mat assembly of claim 13, wherein the mesh member defines therein a third plurality of openings that are laterally spaced apart from the first plurality of openings and the second plurality of openings.

15. The mat assembly of claim 13, wherein ones of the plurality of first mat sections and ones of the plurality of second mat sections are laterally spaced apart from adjacent ones of the plurality of first mat sections and adjacent ones of the plurality of second mat sections, respectively, such that associated first and second mat sections are foldable onto adjacent associated first and second mat sections.

16. A method comprising:
applying an adhesive onto a first plurality of mat sections;
disposing the first plurality of mat sections in a laterally spaced-apart manner;
disposing a mesh member onto the first plurality of mat sections; and
disposing a second plurality of mat sections in a laterally spaced-apart manner onto the mesh member such that the second plurality of mat sections are aligned with the first plurality of mat sections.

17. The method of claim 16, wherein disposing the first plurality of mat sections in a laterally spaced-apart manner includes disposing the first plurality of mat sections on tooling in a laterally spaced-apart manner.

18. The method of claim 16, wherein disposing the second plurality of mat sections in a laterally spaced-apart manner onto the mesh member such that the second plurality of mat sections are aligned with the first plurality of mat sections includes disposing the second plurality of mat sections in a laterally spaced-apart manner onto the mesh member such that a plurality of openings defined in the second plurality of mat sections are aligned with a plurality of openings defined in the first plurality of mat sections.

19. The method of claim 16, further comprising urging the first plurality of mat sections, the adhesive, and the second plurality of mat sections into tacky contact with each other.

20. The method of claim 19, wherein urging the first plurality of mat sections, the adhesive, and the second plurality of mat sections into tacky contact with each other includes rolling the second plurality of mat sections with a roller.
